(19) United States
(12) Patent Application Publication
(10) Pub. No.: US 2003/0233870 A1
(43) Pub. Date: Dec. 25, 2003

(54) Multidimensional sensing system for atomic force microscopy

(75) Inventor: Vladimir Mancevski, Austin, TX (US)

Correspondence Address: THOMPSON & KNIGHT L.L.P., PATENT PROSECUTION DEPARTMENT, 98 SAN JACINTO BLVD., SUITE 1200, AUSTIN, TX, 78701, US

(73) Assignee: Xidex Corporation

(21) Appl. No.: 10/338,381

(22) Filed: Jan. 8, 2003

Related U.S. Application Data
(63) Continuation of application No. 09/907,855, filed on Jul. 18, 2001, now abandoned.

(51) Int. Cl. G12B 21/02; G01B 11/30

(52) U.S. Cl. 73/105; 356/600

(57) ABSTRACT

A scanning probe microscopy tool with innovative sensing system is provided by the present disclosure. This scanning probe microscopy tool includes a special cantilever with partially reflective surfaces that makes the scanning probe tool more capable. This scanning probe microscopy tool also includes at least one light source that illuminates the cantilever with a light beam that need not be focused and may be collimated. In addition, the light beam may be larger than the size of the oscillator and may illuminate more than one cantilever. This scanning probe microscopy tool also includes at least one detector where the preferred detector is a continuous position sensitive detector. The innovative sensing system enables CD-AFM tool configurations where the probe may be twisted about its long axes as to better access vertical and re-entrant surfaces of features, including challenging semiconductor device features with high aspect ratio. The twisted probe may be a twisted cantilever or tip tilted with respect to the cantilever. The innovative sensing system enables measurement of the absolute and relative position and orientation of the probe as the probe interacts with a sample.

### CROSS-REFERENCE TO RELATED APPLICATION

This application is a continuation of U.S. patent application Ser. No. 09/907,855, entitled MULTIDIMENSIONAL SENSING SYSTEM FOR ATOMIC FORCE MICROSCOPY, by Vladimir Mancevski, filed Jul. 18, 2001; claims the benefit thereof under 35 U.S.C. § 120; and hereby incorporates the cited application by reference.

Under 35 U.S.C. § 120, this application claims the benefit of commonly owned U.S. patent application Ser. No. 09/404,880 entitled MULTIDIMENSIONAL SENSING SYSTEM FOR ATOMIC FORCE MICROSCOPY, by Vladimir Mancevski, filed on Feb. 24, 1999, which is also hereby incorporated by reference.

Additionally, via U.S. patent application Ser. No. 09/404,880, and under 35 U.S.C. §§ 119(e) and 120 and 37 C.F.R. § 1.53(b), this application further claims the benefit of commonly owned U.S. Provisional Patent Application No. 60/101,963 entitled MULTIDIMENSIONAL SENSING SYSTEM FOR ATOMIC FORCE MICROSCOPY, by Vladimir Mancevski, filed on Sep. 26, 1998, which is also hereby incorporated by reference.

This application also incorporates by reference commonly owned U.S. patent application Ser. No. 09/881,650 entitled SYSTEM AND METHOD OF MULTI-DIMENSIONAL FORCE SENSING FOR SCANNING PROBE MICROSCOPY, by Vladimir Mancevski, Davor Juricic, and Paul F. McClure, filed on Jun. 13, 2001.

Furthermore, this application also incorporates by reference commonly owned U.S. Pat. No. 6,146,227 entitled METHOD FOR MANUFACTURING CARBON NANOTUBES As FUNCTIONAL ELEMENTS OF MEMS DEVICES, by Vladimir Mancevski.

This application also incorporates by reference U.S. Pat. No. 5,367,373 entitled NONCONTACT POSITION MEASUREMENT SYSTEMS USING OPTICAL SENSORS to Ilene J. Busch-Vishniac, et al. and issued on Nov. 22, 1994, hereinafter “BUSH-VISHNIAC 1,” and U.S. Pat. No. 5,552,883 entitled NONCONTACT POSITION MEASUREMENT SYSTEMS USING OPTICAL SENSORS to Ilene J. Busch-Vishniac, et al. and issued Sep. 3, 1996, hereinafter “BUSH-VISHNIAC 2.”

### TECHNICAL FIELD OF THE INVENTION

The present invention relates generally to the field of scanning probe microscopy tools and, more particularly, to a sensing system for a scanning probe microscopy tool that enables measurement of the absolute and relative position and orientation of an AFM probe and operation of the tool while the AFM probe is positioned and orientated so as to access vertical and reentrant features.

### DESCRIPTION OF RELATED ART

A typical atomic force microscope (AFM) 100 operates as shown in FIG. 1. AFM 100 probes the surface of a sample 10 with a sharp tip 12, which is a few microns long and less than 100 Angstroms in diameter. Tip 12 is located at the free end of a cantilever 14 that is typically 100 to 200 microns long. Forces between the tip 12 and the sample 10 surface cause the cantilever 12 to bend or deflect. A detector 16 measures the cantilever 12 deflection as the tip is scanned over sample, or as sample 10 is scanned under tip 12. The measured cantilever deflections allow a computer 18 to generate a map 20 of surface topography.

Currently available AFMs detect the position of the cantilever with optical techniques. In the most common scheme, shown in FIG. 2, a laser beam 22 bounces off the top surface of the cantilever 24 onto a bi-cell or quadrant cell position detector 26. As cantilever 24 bends, the position of the beam 25 on the bi-cell or quadrant cell detector 26 shifts. As beam 22 shifts, a current imbalance occurs indicating off center position. The feedback system that controls the vertical position of the tip, 27 typically operates in either constant height mode, constant force mode or one of several vibrating cantilever techniques. In constant-height mode, the spatial variation of the cantilever deflection can be used directly to generate the topographic data set because the height of the scanner is fixed as it scans. In constant-force mode, the feedback circuit moves the scanner 28 up and down in the z (i.e., vertical) direction, responding to the topography by keeping the cantilever 24 deflection constant. In this case, the image is generated from the motion of scanner 28. When vibrating cantilever techniques are used, the feedback circuit 29 detects changes in vibration amplitude or phase as tip 12 comes near the sample 10 surface.

The bi-cell or quadrant cell position detectors 26 used to sense cantilever 24 position consist of two or four discrete elements on a single substrate. When a light beam 25 is centered on the cells, output currents from each element are equal, indicating centering or nulling. As the beam 25 moves, a current imbalance occurs indicating off-center position. Bi-cell and quadrant cell detectors 26 require use of a laser beam 22 with an intensity distribution that is constant both spatially uniform and temporally uniform. This is because a nonuniformly shaped or time varying intensity distribution would introduce unwanted bias errors in the output of bi-cell or quadrant cell detector 26. Bi-cell and quadrant cell detectors 26 also require precise alignment and centering of the beam 25 on the bi-cell or quadrant cell detector.

FIG. 3 is a schematic of the noncontact position measurement system 200 previously disclosed in BUSH-VISHNIAC 1 and BUSH-VISHNIAC 2. This system combines optical and computational components to perform high-precision, six degree-of-freedom, (6-DOF) single-sided, noncontact position measurements. For in-plane measurements, reflective optical targets 30 are provided on a target object 32 whose position and orientation is to be sensed. For out-of-plane measurements, light beams 36 are directed toward the optical targets 30, producing reflected beams 34. Electrical signals are produced, indicating the points of intersection of the reflected beams and the position detectors 38. The signals are transformed to provide measurements of translation along, and rotation around, three nonparallel axes which define the space in which the target object moves.

The system comprises two sections, out-of-plane and in-plane. Each section has its own assembly of light sources, reflectors, and sensors. The arbitrarily selected reference plane serves as a reference for motion measurement. This reference plane contains the x and y axes of the three-axis set (x, y and z) which defines the space in which the sensed object moves. The position and/or the motion of the target object are derived from kinematic transformations based on information supplied by the components illustrated in FIG. 3. Position measurements of multiple light beams irradiating a single two-dimensional lateral-effect detector which can be made simultaneously through time, frequency, or wavelength multiplexing. The main advantage of multiplexing is that the number of detectors required in the existing system can be reduced, and the signal processing circuitry can be simultaneously simplified. The resulting system will be more compact, and alignment difficulties will be largely eliminated. Further, the effect of environmental variations is minimized as the number of detectors is reduced.

It is desirable to use a detector 26 that is capable of monitoring the position of a light beam 25 on its surface without the need for precise alignment and centering. Conventional AFM sensing systems 100 provide only the vertical, z, coordinate (or, in one known instance, the horizontal, x, and vertical, z, coordinates), of the cantilever with respect to an absolute reference frame, while relying on the output of a scanning stage for the x and y (or, just the Y) coordinate and providing no information at all about angular orientation of cantilever 24.

It would be desirable to measure all six degrees of freedom without reliance on the output of a scanning stage to determine any of these measured coordinates.

All references cited herein are incorporated by reference to the maximum extent allowable by law. To the extent a reference may not be fully incorporated herein, it is incorporated by reference for background purposes, and indicative of the knowledge of one of ordinary skill in the art.

### BRIEF SUMMARY OF THE INVENTION

The problems and needs outlined above are addressed by the present invention. The present invention provides a multidimensional sensing system for atomic force microscopy (AFM) that substantially eliminates or reduces disadvantages and problems associated with previously developed systems and methods used for AFM.

More specifically, the present invention provides a six degree of freedom atomic force microscope (6-DOF AFM). This 6-DOF AFM includes an AFM cantilever coupled to an AFM tip wherein the AFM tip deflects the cantilever in response to topographical changes on a sample. The AFM cantilever is illuminated by a light beam generated by a light source. This light beam is either collimated or focused. The light is reflected by the top surface of the AFM cantilever towards a detector placed in the path of the reflected light beam. The detector produces an output containing data representing the position and orientation of the AFM cantilever as three translations and three orientations. This output is processed by a data acquisition system to produce a representation of the topographical changes of the sample.

The present invention provides an important technical advantage in that the present invention eliminates the need for precise alignment and centering of the laser beam. A continuous PSD is capable of monitoring the position of a light beam on its surface without the need for precise alignment and centering, as is required when bi-cell or quadrant cell position detectors are used.

The present invention provides another important technical advantage in that the present invention eliminates the need to maintain spatial and temporal uniformity of the laser beam. Use of continuous PSDs eliminates the need to maintain spatial and temporal uniformity of the laser beam, as is required when bi-cell or quadrant cell position detectors are used. This is because continuous position-sensitive detectors (PSDs), unlike bi-cell and quadrant cell detectors, are inherently insensitive to spatial and temporal variations in the laser beam intensity distribution.

The present invention provides yet another important technical advantage in that the present invention eliminates the need for the laser beam spot to illuminate both halves or all four quadrants of the PSD aperture. Use of continuous PSDs, which do not have halves or quadrants, eliminates the need for the laser beam spot to illuminate both halves or all four quadrants of the detector aperture. This feature enables use of a smaller laser beam spot which, in turn, enables operation over larger ranges, since the smaller spot can traverse larger regions of the PSD surface without part of its intensity distribution falling outside the PSD aperture.

The present invention enables sensing of the position and orientation of an AFM cantilever and direct measurement of cantilever position and orientation coordinates in up to six degrees of freedom. Cantilever position and orientation measurements are provided relative to a reference frame that may be fixed with respect to the structure of the AFM or another relative reference frame.

A technical advantage provided by the present invention is the ability to sense the position and orientation of an object in multidimensional space.

Yet another technical advantage provided by one embodiment of the present invention is the ability to repair a workpiece or remove a defect from a workpiece such as a photolithography mask used in semiconductor manufacture.

Another key advantage of the present invention is the ability to examine re-entrant features with an AFM tip. Because a sensing system of the present invention monitors the AFM cantilever as it twists and while it operates in twisted orientation, the sensing system can accommodate large probe angles that can enable the AFM tip to access re-entrant features. Alternatively, the tip itself may be tilted with respect to the cantilever. This eliminates the need to access re-entrant features with boot-shaped tips that are very fragile, expensive, and blunt at the end of the boot.

The present invention is ideal for a variety of uses, including material characterization, chemical-mechanical planarization monitoring, precision surface profiling and critical dimension metrology.

Yet another feature of the present invention is to completely decouple position sensing of an AFM from the mechanical actuator which positions the AFM tip, enabling the present invention to measure at even better resolutions than the ability to position the mechanical actuator itself. Furthermore the present invention may do so while the actuator is in motion. Nonlinearities of the mechanical actuator have no effect on the accuracy of the system. This enables real-time, on-the-fly recording of the AFM cantilever tip position.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical AFM;

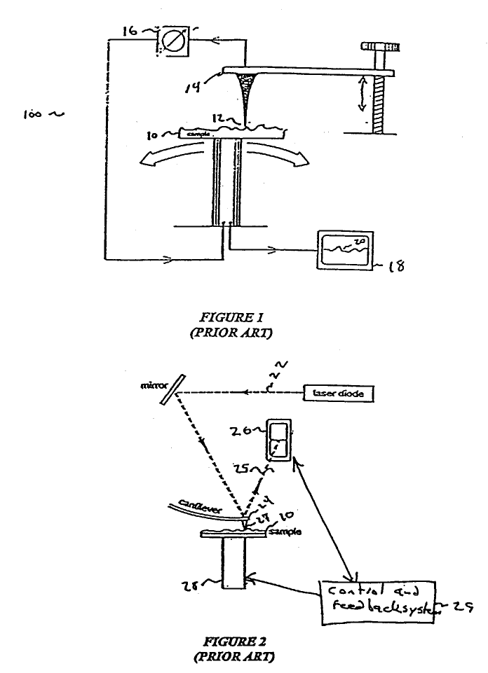

FIG. 2 depicts how an AFM detects position;

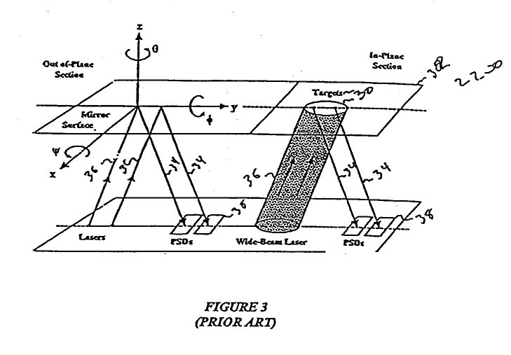

FIG. 3 is a schematic of a previously disclosed noncontact measurement system;

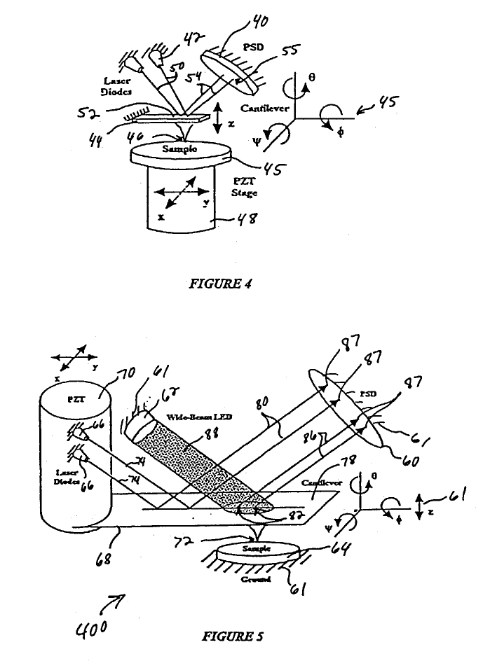

FIG. 4 illustrates one embodiment of a 6-DOF AFM of the present invention;

FIG. 5 presents a second embodiment of a 6-DOF AFM of the present invention.

FIG. 6 provides a representation of two laser beams focused on a cantilever surface;

FIG. 7 shows an alternative embodiment of the present invention that utilizes the cantilever edge as a reflective mark.

FIG. 8 illustrates a standard semiconductor calibration grating used as an AFM sample;

FIG. 9 presents a CD AFM inspection tool provided by the present invention;

FIG. 10 provides a top view of the CD AFM inspection tool provided by the present invention;

FIG. 11 provides a perspective view of the CD AFM inspection tool provided by the present invention;

FIG. 12 presents an actuation mechanism coupled to a cantilever in a AFM of the present invention;

FIG. 13 illustrates an AFM cantilever with a fiducial surface;

FIG. 14 illustrates the method of computation of cantilever absolute position and orientation in one embodiment of the present invention;

FIG. 15 illustrates the sensor actuator concept of operation of a CD AFM of the present invention;

FIG. 16 illustrates a sensing system of the present invention that can access re-entrant features;

FIGS. 17 and 18 illustrate the results of AFM imaging with different x and y step issues;

FIG. 19 illustrates the ability of the present invention to measure absolute linear and angular measurements that are tied to a reference frame;

FIG. 20 illustrates the use of large beams to perform absolute scans over the diameter of the laser beam;

FIGS. 21 and 22 illustrate cosine errors due to bending and tilt;

FIGS. 23 and 24 illustrate adaptation of the present invention designed for mask repair;

FIG. 25 illustrates cantilever position and orientation relative to an absolute reference frame fixed with respect to the structure of the AFM;

FIG. 26 shows how various embodiments of sensing system of the present invention are capable of simultaneous multi-dimensional sensing;

FIG. 27 illustrates a method of scanning contact holes or vias with the system of the present invention; and

FIG. 28 illustrates a procedure for automated tip changing and self alignment.

### DETAILED DESCRIPTION OF THE INVENTION

Preferred embodiments of the present invention are illustrated in the figures, like numerals being used to refer to like and corresponding parts of the various drawings.

The present invention provides Six Degree-of-Freedom (6-DOF) Atomic Force Microscope (AFM) tools for use in microelectronics manufacturing that overcome limitations inherent in the sensing and control system architectures of existing lower degree-of-freedom AFMs. However, the present invention need not be limited to use in microelectronics manufacturing. This 6-DOF sensing system is capable of measuring all six absolute degrees of freedom of a body in space, such as a deflecting AFM cantilever.

The present invention is ideal for a variety of uses, including material characterization, chemical-mechanical planarization monitoring, precision surface profiling and critical dimension metrology. The sensing system of the present invention may be completely decoupled from the actuator, enabling it to measure at even better resolutions than the actuator itself, and do so while the actuator is in motion. The present invention is capable of simultaneous multi-dimensional sensing, as opposed to one-dimensional or several-step multi-dimensional sensing currently performed with existing AFMs. The simple, robust design of the present invention is readily adaptable to multi-cantilever operation.

The sensing system of the present invention may be completely decoupled from the mechanical actuator (stages, PZTs, etc.). Therefore, the cantilever displacements x, y, and z and the cantilever pitch, tilt and yaw angles ψ, φ and θ, are determined independently of actuator motion. Nonlinearities of the PZT or the stage will have no effect on the accuracy of the system. This enables real-time, on-the-fly recording of the AFM cantilever tip position at randomly selected x and y positions.

The present invention uses continuous position-sensitive detectors (PSDs) in lieu of bi-cell or quadrant cell position detectors, with adaptations of a noncontact position measurement system and other component technology innovations that enable sensing of the position and orientation of an AFM cantilever relative to an absolute reference frame.

A first embodiment of the present invention utilizes only the out-of-plane section of the existing 6-DOF sensing system concept. Height z and orientation in pitch and tilt of the AFM cantilever are determined simultaneously for each given x and y coordinate of the sample.

A second embodiment utilizes the entire existing 6-DOF sensing system concept, including both the out-of-plane and in-plane sections. Position in x, y and z and orientation in pitch, tilt, and yaw of the AFM cantilever are determined simultaneously for each unknown x and y displacement of the sample.

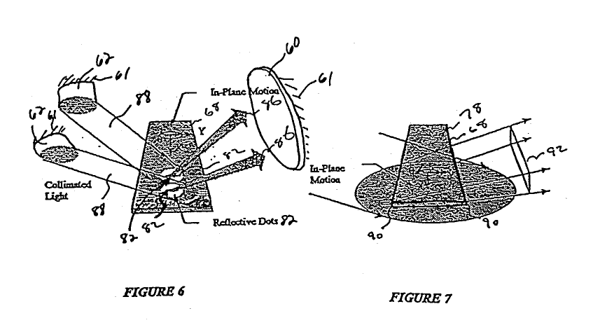

The first embodiment of the present invention utilizes only the out-of-plane section of the 6-DOF sensing system and therefore can only monitor out-of-plane positions and orientations for a given x and y. As shown in FIG. 4, two-dimensional PSD sensor 40, laser diodes 42, and the AFM cantilever 44 are fixed to a ground reference 41, whereas sample 45 is moved under AFM tip 46 in x and y directions with a PZT actuator and a coarse motion stage 48. This configuration relies on already existing external sensors (interferometric, capacitive, etc.) to direct the PZT actuator in the x and y directions. The collimated light beams 50 from laser diodes 42 are pointed toward top surface 52 of AFM cantilever 44 where they bounce off as light beams 54 intercepted by PSD 40. Light beams 50 do not have to be parallel to each other. Care must be taken to assure that light spot 55 from light beams 50 fits on cantilever 44.

The principle of operation of this embodiment of the present invention is as follows. First, the PZT actuator moves the sample 45 under the AFM tip 46 to a precise x and y location. AFM tip 46 will force the AFM cantilever 44 to deflect as it encounters topographic changes on sample 45. These minute deflections will cause light beams 50 to alter their paths to produce light beams 54. These changes are detected by two-dimensional PSD 40. Information about the displacement of the light spots on the surface of the PSD 40 is then used to determine the out-of-plane position z and the pitch and tilt orientations of the cantilever 44.

This AFM configuration can fully and simultaneously determine the vertical position and out-of-plane orientation of AFM cantilever 44. Information about the vertical deflection in z is readily available, either to be displayed as a topography map (in constant height operation) or to provide a predetermined feedback signal to the PZT that will rapidly lift the AFM tip back to its original deflection, keeping a constant force to the cantilever 44 (constant force operation). This first embodiment is suitable for fast-scan multi-dimensional measurements, and also for multi-cantilever operation.

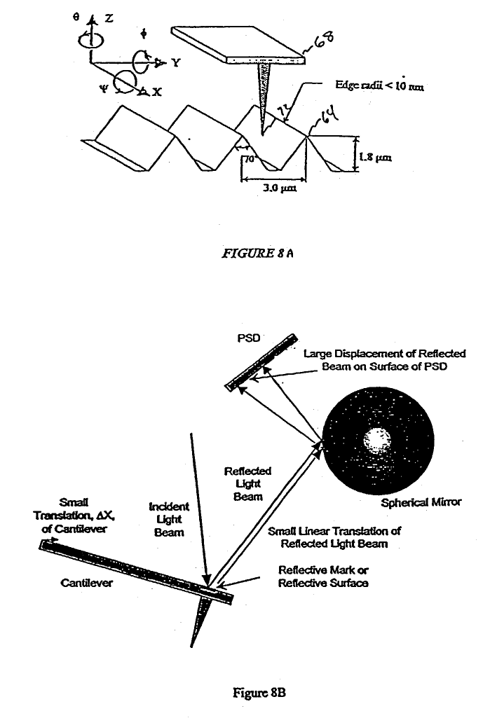

A second embodiment utilizes 6-DOF sensing system, including both out-of-plane and in-plane sections. FIG. 5 represents a second embodiment of the present invention. Two-dimensional PSD 60, wide beam light emitting diode (LED) laser 62 and sample 64 are fixed to ground reference 61. Laser diodes 66 and the AFM cantilever 68 are fixed to the PZT tube 70. PZT tube 70 scans AFM tip 72 above sample 64 in the x and y directions and, if necessary, adjusts its vertical displacement, z. The laser diodes 66 are fixed to the bottom of PZT tube 70 so that laser diodes 66 can move together with cantilever 68 in the X-Y plane parallel to sample 64 to keep the collimated light beams 74 on the surface of the cantilever 68 at all times. Care must be taken that light spots 76 from light beams 74 fit on cantilever 68. Care must also be taken that laser diodes 66 do not twist while moving with PZT tube 70. This maintains a constant slope for light beam 74. In the alternative, a larger cantilever area with the size of the scan may accommodate light spots 76 by keeping them within cantilever 68 surface 78 during the scan. Collimated light beams 74 from laser diodes 66 are pointed towards top surface 78 of AFM cantilever 68 where collimated light beams 74 are reflected off surface 78 and are intercepted by PSD 60 as light beams 80. This part of sensing system 400 is responsible for determining the out-of-plane position and orientation.

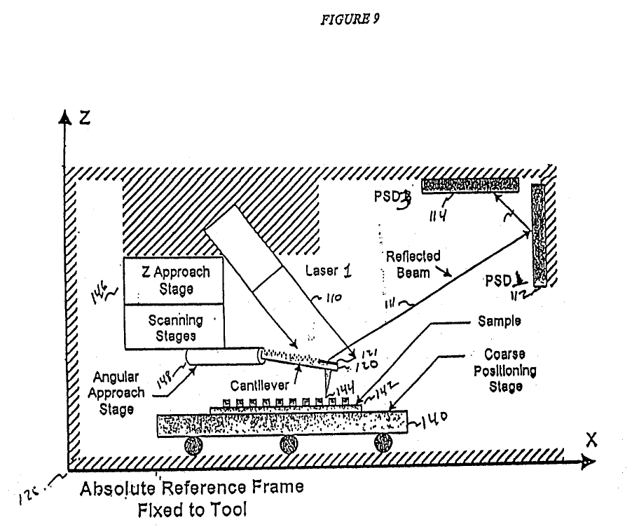

For the in-plane part of the sensing system 400, cantilever 68 is equipped with two reflective marks 82 on a nonreflective background, as also shown in FIG. 6. Collimated light 88 from the wide beam LED 62 illuminates reflective marks 82 on cantilever 68, where the light beam reflections 86 created by reflective marks 82 bounce toward PSD 60 (or multiple PSDs). Care must be taken that wide beam 88 covers reflective marks 82 at all times during scanning of cantilever 68. Because the AFM scanning ranges are typically 10-100 μm, this task can be readily accomplished.

Referring to FIG. 5 again, PZT tube 70 first moves AFM tip 72 above sample 64 to an unknown x and y location. As AFM tip 72 encounters topographic changes, AFM cantilever 68 will be deflected. These minute deflections will cause light beams 80 and 86 to alter their paths and move light spots 87 on two-dimensional PSD 60 to new two-dimensional locations. These changes are then detected by two dimensional PSD 60, and used to determine the out-of-plane position z and the pitch and tilt orientations of the cantilever. The X-Y motion and deflection of AFM cantilever 68 also cause a deflection of the light beams 86 created by the reflective marks 82. Two-dimensional PSD 60 will then detect the displacement of the light spots on the surface of PSD 60, and use that information to determine the in-plane positions x and y and the yaw orientation of the cantilever. Therefore all three positions and all three orientations can be determined simultaneously.

The significance of this embodiment is that the full position and orientation of AFM cantilever 68 can be determined directly and simultaneously from information provided by the PSD 60 without prior knowledge of how the cantilever arrived in its final position. This means that this second embodiment of the 6-DOF AFM of the present invention is insensitive to any system imperfections, such as the PZT nonlinearities and nonorthogonality between the sample and the PZT axis. This enables real-time, in-flight recording of the AFM cantilever tip 72 at randomly selected x and y positions. Complete decoupling of the actuator from the sensing system means that the 6-DOF AFM can measure at even better resolutions than the actuator itself, and do so while the actuator is in motion.

The basic modes of operation of the 6-DOF AFM of the present invention can be contact, non-contact, and attractive-repulsive. In contact mode with constant-height operation, AFM tip 72 will scan above sample 64 surface while the position and orientation of cantilever tip are determined.

In contact mode with constant-force operation, information about the vertical deflection z of cantilever is used to drive the laser beam to its original position, keeping the cantilever force constant. The limits where the constant-height mode must switch to a constant-force mode due to large topography changes have yet to be determined. The laser beam(s) that monitor the AFM cantilever can be moved, in constant-force mode, closer to the center of the PSD where the AFM can again be operated in constant-height mode.

Typically, a vibrating AFM cantilever has a resonant frequency above 100 KHz, whereas the PSD, due to its response time limitations, can only monitor up to 50 KHz signals. If a longer AFM cantilever with lower resonant frequency is used, then the non-contact vibrating tip mode is applicable. The improved tip control made possible by the 6-DOF system will enable a low frequency non-contact mode to be implemented, in which the tip functions as both a contact and non-contact AFM (called here an “attractive-repulsive mode”).

The ability to determine the orientation of cantilever 68 provides the unique capability to detect lateral forces while scanning in either the x or y directions. This is particularly important for material characterization studies. It also provides the capability to precisely detect the exact vertical deflection vs. the x and y location, whereas many AFMs have an error component in x and y due to the cantilever's deflection in z. This problem has appeared, for example, when imaging adhesion forces on proteins with an AFM.

Cantilever 68 selected for the present invention must have size, shape, and other physical properties consistent with cantilevers used in the AFM industry. The present invention also requires that AFM cantilever 68 serve as a reflective surface. Rectangularly shaped cantilevers, 35 μm wide and 350 μm long, are used in one embodiment of the present invention. The reflective sides are coated with aluminum, making them highly reflective. However, the present invention need not be limited by this shape, size and coating for the cantilever.

In the first embodiment of the 6-DOF AFM of the present invention, as shown in FIG. 4, two separate laser beams 50 were focused on surface 52 of cantilever 44, either on top of each other, or next to each other along the length of cantilever 44. For the second embodiment, FIG. 5 also provides a representation of two laser beams 74 focused on cantilever surface 78.

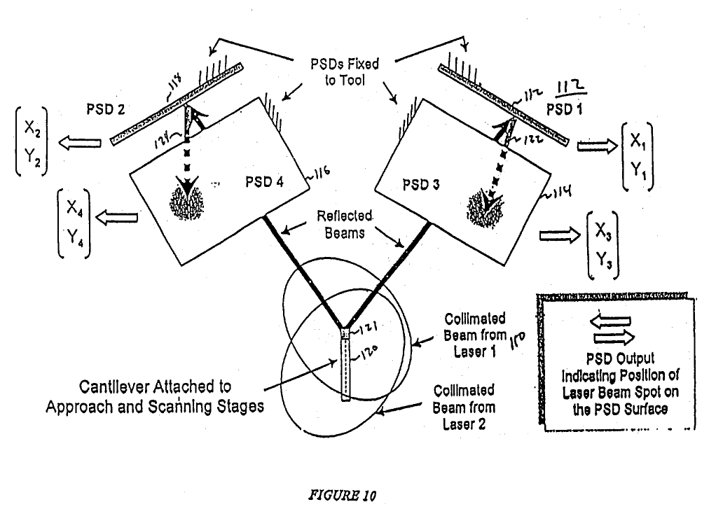

A cantilever 68 with two reflective marks 82 is shown in the second embodiment of FIG. 5. Reflective marks 82 provide a means to use the cantilever itself for measuring in-plane motion instead of relying on the sample stage. One reflective mark allows the detection of in-plane cantilever displacements (x and y) as shown in FIG. 6. Two reflective marks allow the detection of the in-plane rotation (cantilever's yaw angle θ). Reflective marks 82 each have a diameter smaller then the width of cantilever 68 and are placed close to the free end of the cantilever, side by side along its length, as shown in FIG. 6. Cantilever edge 90 itself can be used in lieu of a reflective mark to define a reflective region 92. This alternative embodiment for detecting in-plane motion shown in FIG. 7.

The single reflection from cantilever surface 78 depicted by the rectangular region 92 shown in FIG. 7 enables the detection of both in-plane cantilever displacements x and y. This may also be achieved by having two reflective strips along the length of the cantilever 68 separated by a non-reflective strip. Fabrication of such reflective strips is less complicated and less expensive then fabrication of two reflective dots within the cantilever. In addition, because such reflective strips are larger in size, the reflective strips produce more intense reflected light then the reflective marks. Increasing intensity reflected from the cantilever improves the signal-to-noise ratio of detection electronics. In the reflective strip design, the focused light beam (used for the out-of-plane measurement) will also use one of the reflective strips as the reflective surface needed to monitor the cantilever's out-of-plane displacement.

The 6-DOF AFM sensing system of the present invention required changing the beam shapes. In the first embodiment of the present invention, the diameter of narrow-beam laser 50 had to be less than the cantilever width. Therefore, a focused laser beam having a diameter less than the width of the cantilever at its focal distance may be used. A focused laser beam can function similarly to a narrow collimated beam for purposes of determining the out-of-plane components. The transformation equations used to compute the absolute position and orientation of the cantilever based on PSD outputs may need to be modified to take account of beam shape effects when focused beams are used instead of collimated beams.

One embodiment of the present invention specifically uses lasers specified as having 18 μm beam diameter at 100 μm focal distance. The 100 μm focal length provides adequate space for positioning the laser mounts, stage, PSD mounts and other components. Optics may be modified to change the focal length of a laser. Modifying these focal lengths allows the laser casings to be positioned next to each other and focused at the same spot on the cantilever.

Excessive beam diameter cause unwanted reflections from the edges of the cantilever. With a smaller laser beam, the quality of the laser light is improved and the signal to noise ratio significantly increased. In addition, a better focused laser beam provides a reflected beam with higher light intensity. This higher light intensity improves the signal to noise ratio of the system. Unwanted effects of the cantilever edges on the quality of the reflected laser beam provide that smoother edges, or reflective strips that do not extend out to the edges of the cantilever, will provide a higher quality reflected beam.

In the in-plane AFM implementation, shown as FIG. 5, the diameter of the wide beam laser 88 must be large enough to allow the reflective marks 82 to displace within the beam for at least 100 μm, which corresponds to the range required for of a typical AFM scan. Otherwise, the reflective mark 82 or strip would fall outside the region illuminated by beam 88. If reflective mark or strip 82 is 35 by 35 μm, the wide beam should be approximately 100 μm to allow for 30 μm scans while keeping the reflective regions within the aperture of the collimated beam. One specific embodiment of the present invention uses a pseudo-collimated wide-beam laser light that is commercially available. This laser light has a diameter of 100 microns and depth of focus of 2 mm. The pseudo-collimated light was produced by using a focused light beam with a large depth of focus.

Continuous-position PSDs are robust with respect to the laser beam's shape, intensity variation over the beam profile, temporal intensity variation, and the position of the laser beam with respect to the physical center of the PSD when compared to split PSDs. Surface-mounted, tetra-lateral, two-dimensional (5×5 mm) PSDs may be used in embodiments of the present invention.

The required surface area of the PSD depends on the diameter and divergence of the beam reflected from the reflective region on cantilever. This is because the incident light spot must fit within the PSD aperture. When using focused rather than collimated light beams, the distance between the PSD and the cantilever also plays a role. At some focal distances, the laser beam may be larger than the cantilever, resulting in the reflection from the cantilever edges producing a reflected light beam with a very irregular, non-continuous shape.

At certain distances from the cantilever, most but not all of the light intensity distribution of the reflected laser beams may fall within the PSD apertures. Using larger PSDs enables the present invention to capture the entire intensity distribution. However, based on the physics of these devices, a larger PSD area would result in decreased device resolution. Achieving high resolution is an important objective. The split PSDs typically used in conventional AFMs cannot detect anything from this type of reflected laser light. The fact that the present invention is able to obtain a degraded, but still meaningful measurement demonstrates that the present invention is robust in relation to intensity variations over the beam profile.

A major challenge overcome by the present invention in the use of multiple lasers with an AFM cantilever is the difficulty of aligning the reflected laser beams with the PSDs. Split PSDs used with most AFMs cannot overcome this difficulty because multiple laser beams would have to be aligned with the centers of the split PSDs so as to allow the laser beam to illuminate all four quadrants, while maintaining uniform beam shape and intensity. Continuous position PSDs do not have this disadvantage because they can accommodate a laser beam with arbitrary shape and non-uniform intensity. In addition, a continuous position PSD can also be positioned away from the centroid of the incident beam, as long as this does not cause the beam to fall outside the PSD aperture.

Embodiments of the present invention may use both AC and DC modulated lasers. The constant (DC) laser beam intensity produced a more stable signal in relation to drift and noise, but it also increased the sensitivity of the PSD signal to variations in environmental lighting conditions and to the quality of the laser. The AC scheme approach should shift the electronic signals to frequency bands where the noise floor is lower, thereby further improving signal-to-noise-ratio and, with it, overall system resolution.

Phase lock loop amplifiers are ordinarily used when superior signal recovery capability is required. However, embodiments of the present invention may use a 6-DOF AFM without using phase lock loop amplifiers. If phase lock loop amplifiers are used, several phase lock loop amplifiers are needed to process the signals from two PSDs. Embodiments of the present invention demonstrate the ability to achieve nm-scale resolution without using phase lock loop amplifiers. A more refined resolution and repeatability may be achieved with the use of phase lock loop amplifiers in the circuit.

A piezoelectric transducer (PZT) stage is capable of moving either the sample or the AFM cantilever in the x, y and z directions. Typical PZT stages are available from Piezosystem Jena, with 80 μm range in x and y, and 9 μm in z.

The function of the data acquisition system (DAQ) is to acquire the signals from the PSD signal processing circuits. These signals are digitally filtered to parse the acquired data into frequency components, average the signals, normalize the signals, display and store the experimental data, and provide analog output to drive the PZT stage in all three axes.

A package such as National Instruments' LabView software and data acquisition hardware may be used in the DAQ. The measurements may be taken on-demand or during continuous sampling. The results may be processed by passing the PSD output signal through a Fourier transform and discarding all frequency components except the residual DC signal. Each data point represents a sample average of this DC signal, acquired at a sampling rate of 10 KHz per channel. This number of samples is empirically based on minimizing the observed standard deviation. However, the present invention need not be limited by this method of sampling.

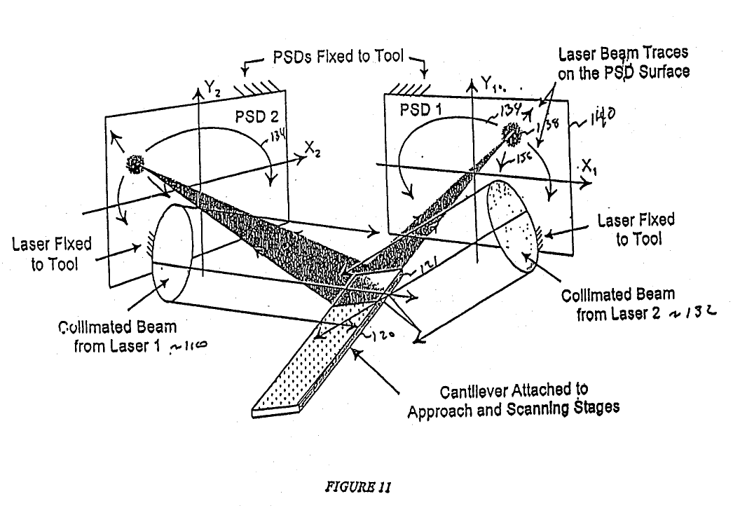

A calibration grating may be used as an AFM sample. A standard semiconductor calibration grating with pyramidal ridges, 1.8 μm high and 3 μm apart, with their faces aligned at 70° with respect one another is shown in FIG. 8.

The simple, robust design of a 6-DOF AFM will make it readily adaptable to multi-cantilever operation. Because the continuous PSD is better for alignment and centering, it is more suitable for monitoring the position of many light beams, where each is from a different cantilever. A single continuous PSD can be used to monitor more than one light beam from more than one than one cantilever. In a multi-probe application the sample will be displaced by a piezoelectrically actuated stage in the same x and y step under each AFM cantilever tip. A separate sensing system will be used to instantaneously determine the z position, or the z position plus the orientation, of each individual cantilever. This information about position and orientation can be used to independently control the height and orientation of each cantilever.

The embodiments previously described are not the only possible AFM architectures that can be implemented with the multidimensional sensing system. Different embodiments of the invention include different positions and orientations of the lasers and the PSDs with respect to each other, and with respect to the AFM cantilever. Another embodiment involves the number of the lasers and PSDs. Using multiplexing schemes, one could reduce the number of PSDs so that one PSD monitors more then one laser light. Another embodiment utilizes beam-splitters that enable a single laser beam to illuminate different sensed bodies, of which one or more are AFM cantilevers (two AFM cantilevers or an AFM cantilever and a reference body). Still another variation uses a single reflected laser beam that illuminates more then one PSD. This approach is effective in reducing the number of lasers.

Another embodiment uses mirrors to manipulate the laser beam to reach an AFM cantilever when direct pointing from a laser is hard, or to divert the light beam path to improve the sensing.

An additional embodiment of an AFM sensor-actuator uses only one or more fiducial surfaces to detect all six degrees-of-freedom of a body in space, including an AFM cantilever. This embodiment departs from the previously described approach where the out-of-plane sensing and the in-plane sensing are done separately with different types of laser beam light (narrow beam collimated, wide beam collimated, focused). The combination of reflective surface and fiducial surface is replaced by a fiducial surface. Although this AFM sensor-actuator configuration can be used for a variety of applications suitable for AFMs, such as roughness measurement, inspection of chemical-mechanical-planarization (CMP) wafer processes, the present invention is well suited for critical dimension atomic force microscopy (CD AFM). As CD AFM inspection involves sudden topography changes and vertical or re-entrant sidewalls, CD AFM inspection is the most challenging application for an AFM based tool.

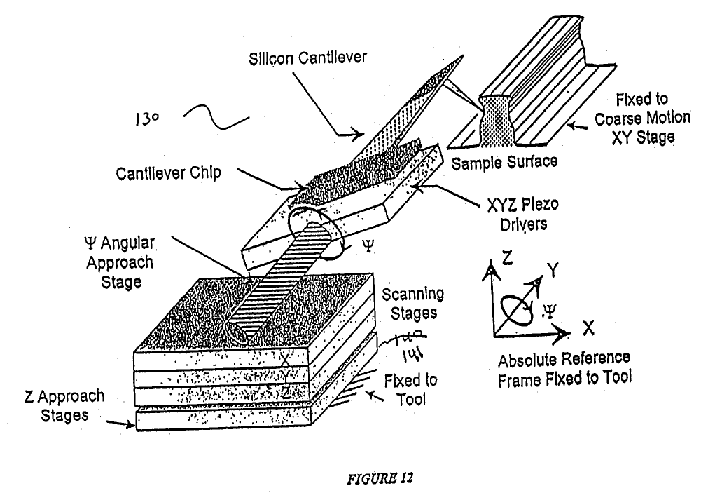

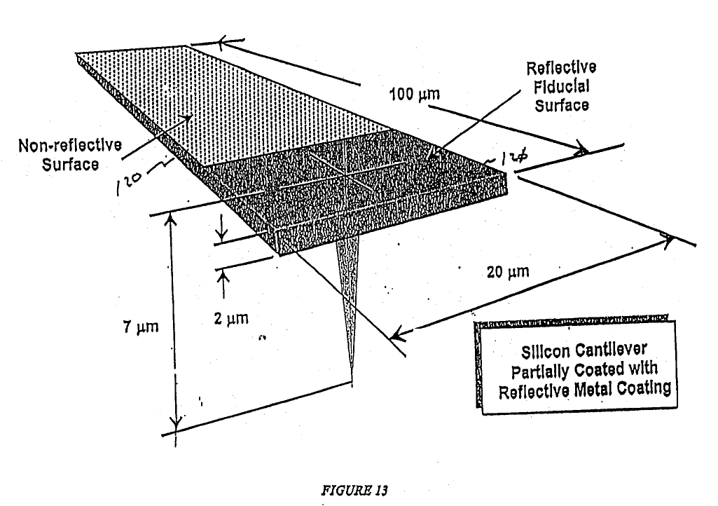

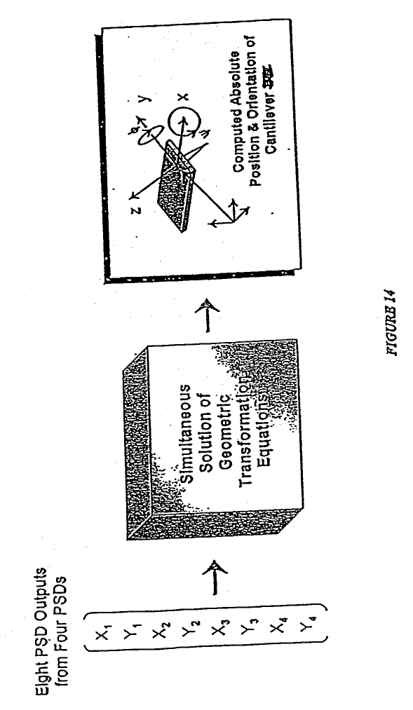

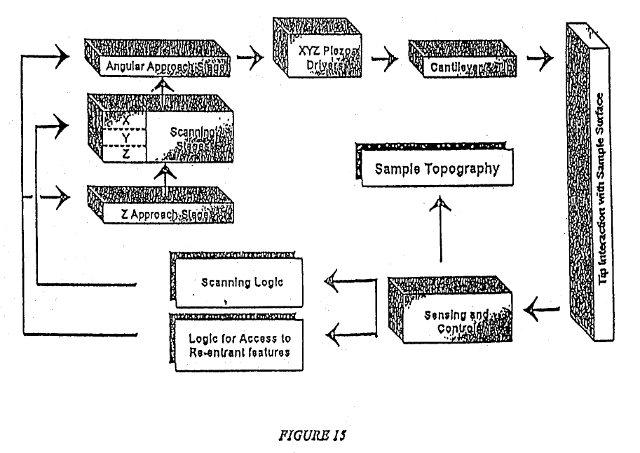

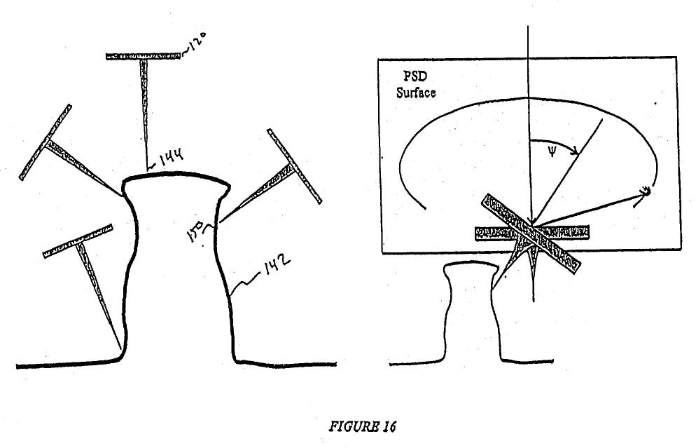

FIG. 9 presents a side view of this CD AFM architecture configuration. The architecture consists of two collimated laser beams and four PSDs. FIG. 9 shows the side view and therefore only one laser 110 and the corresponding pair of PSDs (PSD 1 112 and PSD 3 114). A second laser and a second pair of PSDs are behind the first laser-PSD set. FIG. 10 provides a top view of the entire sensing system. FIG. 11 shows the perspective view of the sensing system but does not show the secondary PSDs (PSD 3 114 and PSD 4 116) as shown in FIG. 10 that detect the laser beams 122 and 124 reflected off the primary PSDs (PSD 1 112 and PSD 2 118). Lasers 110 and 111 and PSDs 112, 114, 116 and 118 are all fixed to absolute reference frame 126 and the cantilever 120 is attached to an actuation mechanism 130 shown in FIG. 12. FIG. 13 presents a cantilever suitable for this embodiment. Use of one fiducial and three PSDs allows detection of five absolute degrees-of-freedom (the sixth one, yaw about the z axis, is not determined using only one fiducial). However, use of four PSDs provides sensing redundancy. Use of a second fiducial requires four PSDs and will allow determination of the yaw, but also adds an extra necessary complexity in constructing a sensing system. For AFM applications, yaw of standard AFM cantilever is not important, and therefore the presented embodiment does not include this but may be incorporated.

The principle of operation is as follows. A collimated laser beam from laser 110 is pointed toward an AFM cantilever 120 with fiducial surface 121. Fiducial surface 121 reflects a primary reflected beam 111 towards a PSD 112. With the help of beam-splitters one can split the reflected laser beam towards PSD 1 112 and PSD 3 114. The principle is the same for a second laser 132 and PSDs 2 118 and 4 116. In the presented architecture the primary PSDs 112 and 118 function as a mirror that reflects the primary reflected laser beam 111 towards the secondary PSDs 114 and 116. Available off-the-shelf PSDs reflect enough light to achieve the second laser beam bounce. Additional coatings can further improve the quality of the secondary reflected light 122 and 124. In any case, the electronic processing for the primary and secondary PSDs must account for the different laser beam intensity of the primary and secondary laser beam. The use of secondary reflected laser beam replaces the need for an extra laser. Without the secondary reflected laser beam one would need four lasers. A pair of primary and secondary PSDs in principle enables the detection of the directionality of the laser beam, which is not possible with a single PSD.

As cantilever 120 moves to a different position and orientation under the flood of collimated laser beam 110, fiducial surface 121 reflects the laser beams to a new position on the surface of the four PSDs. For example, a cantilever twist (Ψ) around its axis as shown in FIG. 12 would create a laser beam trace on the surface of the PSD in a shape of an arch 134 shown in FIG. 11, and a z displacement would produce up-down trace 136.

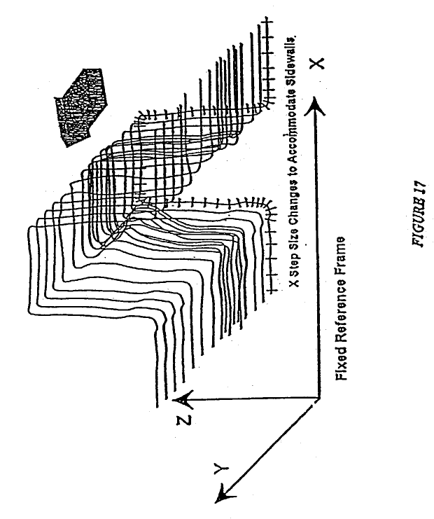

The output from the PSDs is the two-dimensional position of the laser spot 138 on the surface 140 of the PSD. An electrical current output from the PSDs is electronically and then digitally processed. The eight PSD outputs are part of a set of eight independent nonlinear equations with five unknowns. Simultaneous solution of the decoupled equations, or numerical solution of the coupled equations produces the absolute position and orientation of the AFM cantilever as illustrated in FIG. 14.

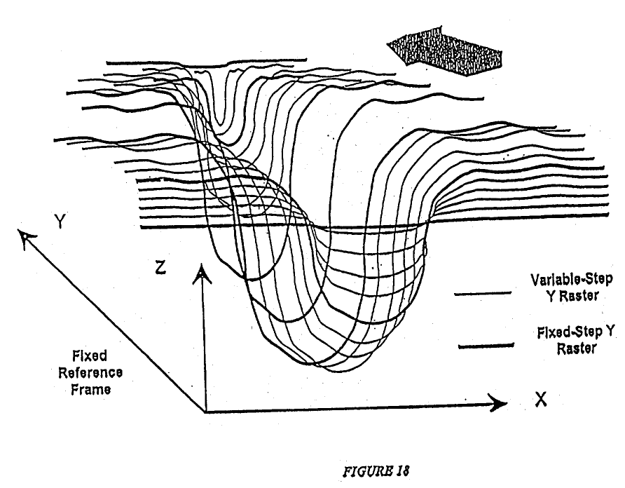

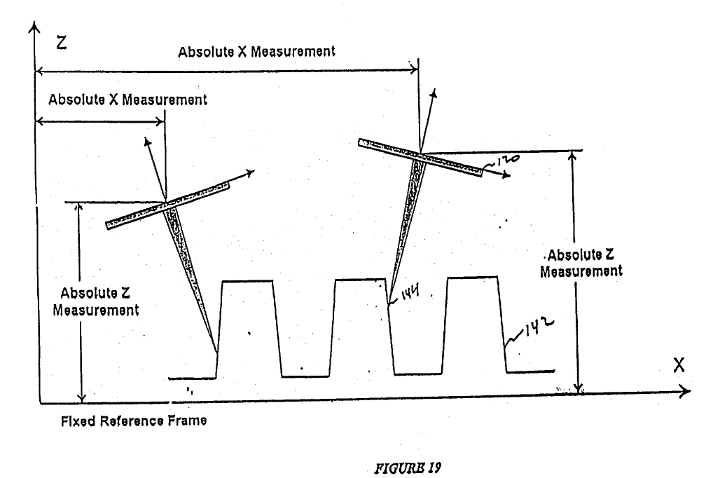

FIGS. 9, 12 and 15 show the functioning of the actuating system for a CD metrology application. The sample is attached to a coarse XY stage 141 that is used to position the sample 142 (semiconductor wafer with ICs) under the AFM tip 144. AFM cantilever 120 is approached with the help of a z approach stage 146 that has as large a range (on the order of 100 mm) and as needed twisted in Ψ (with the help of the angular approach stage 148) as to allow tip 144 to reach undercut features. Angular approach stage 148 is mounted atop the XYZ PZT stage 146 that is used for scanning AFM tip 144 across sample 142. A 3-D PZT driver that is used to drive (vibrate) the cantilever 120 is attached to the angular approach stage 148. The cantilever is attached to the PZT driver module. This actuation system allows AFM tip 144 to be positioned with respect to a feature on sample 142. Because the sensing system monitors AFM cantilever 120 as it twists, the sensing system can accommodate large twist angles that can enable tip 144 to access re-entrant features 150 as shown in FIG. 16. The only other way to currently access re-entrant features is with boot-shaped tips that are very fragile, expensive, and blunt at the end of the boot.

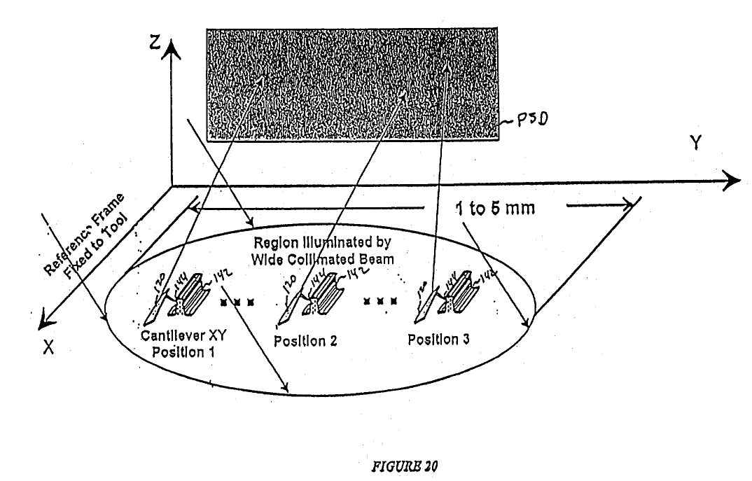

The present invention also allows operating the cantilever and the tip in the x, y, and z directions. This enables one to determine all components of a 3-D vector normal to the surface, the length of which is equal to the distance from tip 144 to the surface of sample 142 and the XYZ position of the corresponding point on the sample surface. The 3-D capability of the CD AFM of the present invention enables a new AFM scanning strategy where the raster step in y can be altered for faster AFM imaging and better inspection of profiles in y direction that might have been omitted if one did not have information about the y direction and scanned with constant y raster step as illustrated by the results presented in FIGS. 17 and 18. It is also possible to scan in the XY direction.

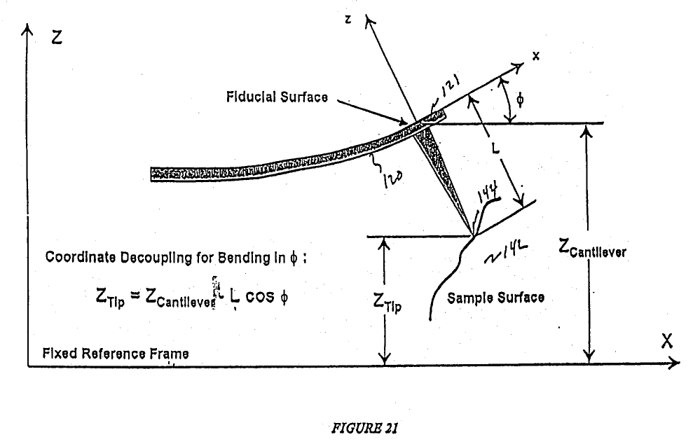

Since the PSDs of the sensor-actuator system always track the reflected laser beams from the cantilever 120. The present invention enables measurement of absolute linear and angular measurements tied to a fixed reference frame. FIG. 19 illustrates this capability which is not possible with existing AFMs.

Tracking of cantilever 120 directly with the sensing system also enables XY measurements independent of the scanning stage. In existing AFMs the XY measurements are provided by an external sensor.

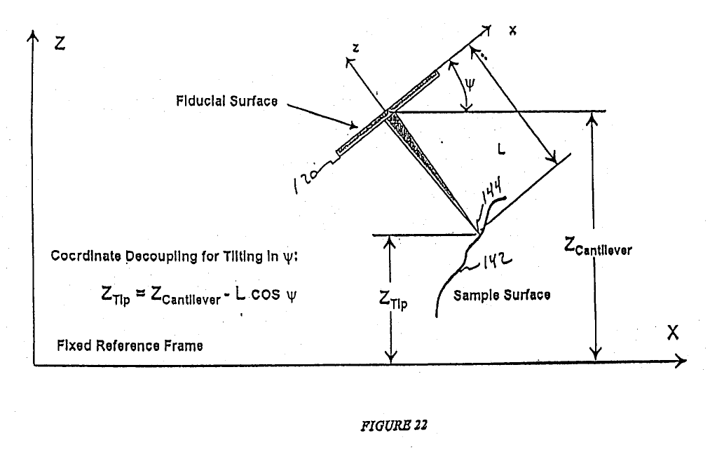

Use of large collimated beams and use of a fiducial surface enables absolute scans over the diameter of the laser beam, 1 to 5 mm as shown in FIG. 20. Existing AFMs do not even have an absolute reference frame and cannot scan more then 100 μm without saturating the sensing system.

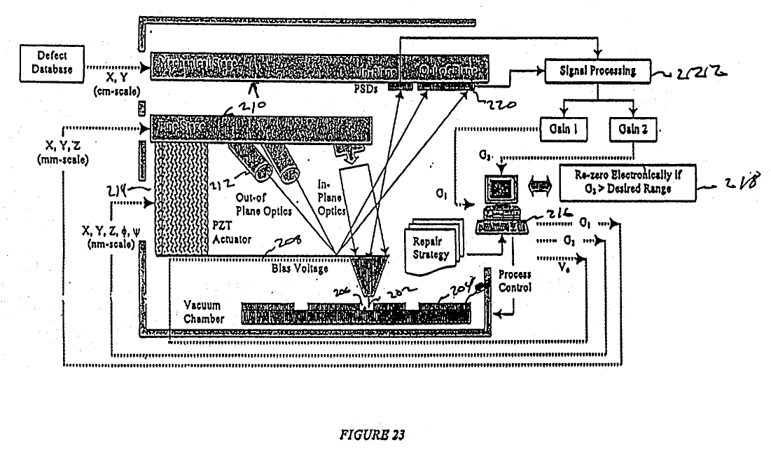

Yet another advantage of the CD AFM of the present invention is the elimination of the cosine errors due to cantilever bending and tilt, vertical tip and sample alignment, and x and y orthogonality error. These errors occur when the sensing system measures coupling of the displacements. Since all coordinates are determined simultaneously, measurements are decoupled. FIGS. 21 and 22 illustrate cosine errors due bending and tilt.

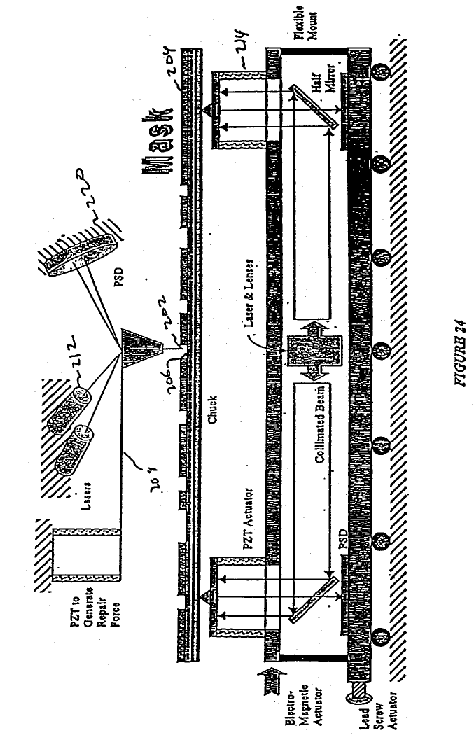

Other configurations possible with the sensing system include special adaptations designed for mask repair, as shown in FIGS. 23 and 24.

A micro-machining tool or, in one embodiment, a mask repair tool is illustrated in FIGS. 23 and 24. In this embodiment, the AFM tip 202 may be used to either perform a quality assurance check on the profile of the mask structures 204 or remove a defect from the mask 206 or repair a defect on a mask structure 204 on mask 206. In this embodiment, the AFM tip 202 is coupled to AFM cantilever 208 which is positioned by a mechanical stage 210.

Mechanical stage 210 consists of at least one laser source 212 and a PZT actuator stage 214 coupled directly to AFM cantilever 208.

Motion of AFM tip 202 through mechanical stage 210 cantilever is controlled by a computer control system 216. This computer control system 216 will contain software to process data on workpiece or mask 206 to determine the location of defects 218 on mask 206 and coordinate the removal and/or repair of defects 218 from the workpiece.

Laser sources 212 contained within mechanical stage 210 provide collimated laser beams to measure out-of-plane and in-plane movements of AFM cantilever 208 as described in earlier embodiments.

A knowledge of the geometry of how AFM tip 202 is coupled to AFM cantilever 206 allows one to determine the position of AFM tip 202 from a knowledge of the position of AFM cantilever 206.

The present invention may use laser sources 212 to provide a laser beam 218 which is reflected from a surface, wherein the surface may be the top surface of cantilever 206, towards PSDs 220. The system will utilize at least one PSD 220 to determine a variable describing the location and orientation of AFM cantilever 206. The present invention may determine the x coordinate, y coordinate and z coordinate, as well as the pitch angle, yaw angle and tilt angle or any combination of these variables associated with the position and orientation of the AFM cantilever from the reflected beams onto continuous PSD 220 apertures. These PSDs may be continuous PSDs, however need not necessarily be continuous PSDs. PSD 220 provides an output signal to a signal processing system 222 which will then determine the location of AFM tip 202 from the outputs of PSDs 220. This information is supplied to control system 216 to reposition the AFM tip 202 as needed or desired to execute a repair strategy. In one embodiment of the present invention, AFM tip 202 may be used to mechanically agitate or remove a defect from an object. In another embodiment, AFM tip 202 may be used to repair an object on the workpiece or mask 206, as described in FIGS. 23 and 24. In a further embodiment, AFM tip 202 may be used to deposit a material to repair a structure on the workpiece or mask 206.

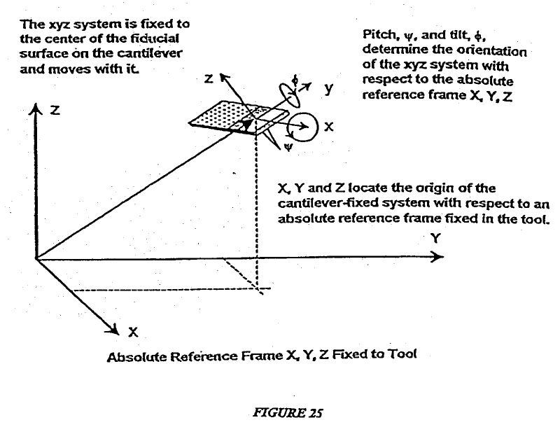

Cantilever position and orientation measurements are provided relative to an absolute reference frame fixed with respect to the structure of the AFM as shown in FIG. 25. This is in contrast to conventional AFM sensing systems that provide only the vertical, z, coordinate (or, in one known instance, only the horizontal, x, and vertical, z, coordinates), of the cantilever with respect to an absolute reference frame. Conventional AFM sensing systems rely on the output of a scanning stage for the x and y (or, just the Y) coordinate and providing no information at all about the cantilever's angular orientation.

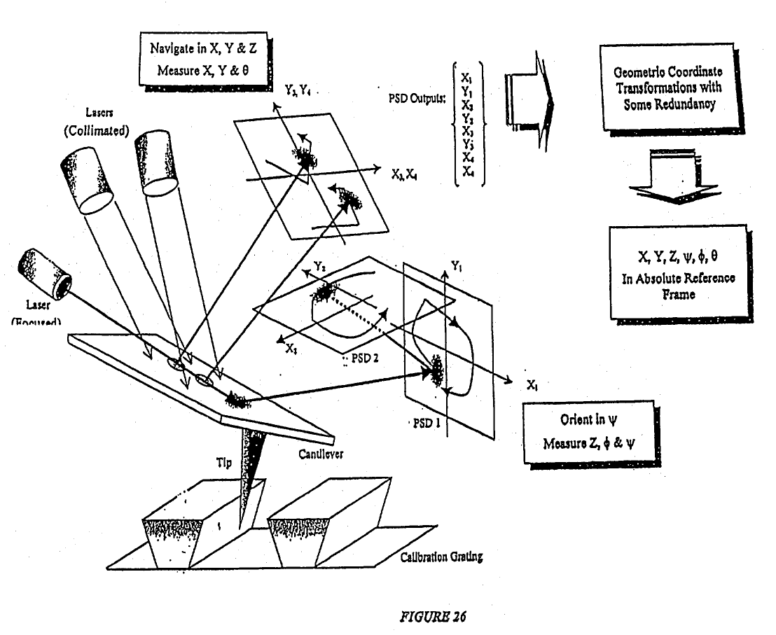

Various embodiments of the six-degree-of-freedom sensing system of the present invention are capable of simultaneous multi-dimensional sensing, as opposed to one-dimensional or several-step multi-dimensional sensing currently performed with existing AFMs as illustrated in FIG. 26.

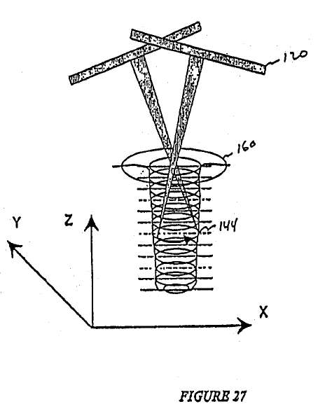

The present invention provides a method of scanning contact holes and vias as shown in FIG. 27. Here cantilever 120 is tilted so as to allow access of tip 144 to one sector of the curved sidewall of hole or via 160. Tip 144 is scanned in XY and rastered in z. Cantilever 144 is then tilted in the other direction so as to allow access of the tip to another sector of the curved sidewall. Tip 144 is again scanned in XY and rastered in z. The results of the scans are combined to provide contour lines 162 describing the surface of hole or via 160.

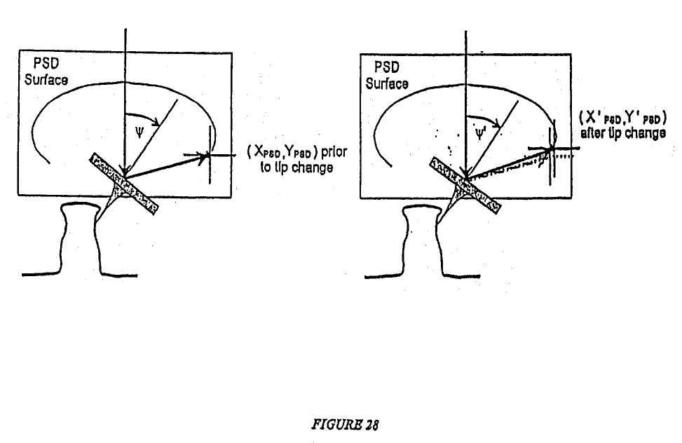

FIG. 28 illustrates how the multidimensional sensing system adapted to an AFM can be used for automated tip changing. The multidimensional sensing system uses PSD outputs, x ′PSD and y ′PSD , to calibrate new cantilever orientation angles, ψ and φ, after a tip change. The XYZ stage then reapproaches the sample and resumes scanning.

Position in x, y and z and orientation in pitch, tilt, and yaw of the AFM cantilever are determined simultaneously for each unknown x and y displacement of the sample.

The present invention provides an important technical advantage in that the present invention eliminates the need for precise alignment and centering of the laser beam. A continuous PSD is capable of monitoring the position of a light beam on its surface without the need for precise alignment and centering, as is required when bi-cell or quadrant cell position detectors are used.

The present invention provides another important technical advantage in that the present invention eliminates the need to maintain spatial and temporal uniformity of the laser beam. Use of continuous PSDs eliminates the need to maintain spatial and temporal uniformity of the laser beam, as is required when bi-cell or quadrant cell position detectors are used. This is because continuous position-sensitive detectors (PSDs), unlike Bi-cell and quadrant cell detectors, are inherently insensitive to spatial and temporal variations in the laser beam intensity distribution.

The present invention provides yet another important technical advantage in that the present invention eliminates the need for the laser beam spot to illuminate both halves or all four quadrants of the PSD aperture. Use of continuous PSDs eliminates the need for the laser beam spot to illuminate both halves or all four quadrants of the PSD aperture. This feature enables use of a smaller laser beam spot which, in turn, enables operation over larger ranges, since the smaller spot can traverse larger regions of the PSD surface without part of its intensity distribution falling outside the PSD aperture.

Also, use of continuous PSDs instead of bi-cell or quadrant cell position detectors eliminates the need to maintain spatial and temporal uniformity of the laser beam. This is because continuous position-sensitive detectors (PSDs), unlike bi-cell and quadrant cell detectors, are inherently insensitive to spatial and temporal variations in the laser beam intensity distribution. Using continuous PSDs also means the laser beam spot is not required to illuminate both halves or all four quadrants of the PSD aperture. This feature enables use of a smaller laser beam spot which, in turn, enables operation over larger ranges, since the smaller spot can traverse larger regions of the PSD surface without part of its intensity distribution falling outside the PSD aperture.

The present invention enables sensing of the position and orientation of an AFM cantilever. Present invention allows direct measurement of cantilever position and orientation coordinates in all six degrees of freedom without reliance on the output of a scanning stage to determine any of these measured coordinates. Cantilever position and orientation measurements are provided relative to an absolute reference frame fixed with respect to the structure of the AFM.

A technical advantage provided by the present invention is the ability to sense the position and orientation of an object in multidimensional space.

Yet another technical advantage provided by one embodiment of the present invention is the ability to repair a workpiece or remove a defect from a workpiece such as a photolithography mask used in semiconductor manufacture.

Another key advantage of the present invention is the ability to examine re-entrant features with an AFM tip. Because a sensing system of the present invention monitors AFM cantilever as it twists, the sensing system can accommodate large twist angles that can enable the AFM tip to access re-entrant features. This eliminates the need to access re-entrant features with boot-shaped tips that are very fragile, expensive, and blunt at the end of the boot.

The present invention is ideal for a variety of uses, including material characterization, chemical-mechanical planarization monitoring, precision surface profiling and critical dimension metrology.

Yet another feature of the present invention is to completely decouple position sensing of an AFM from the mechanical actuator which positions the AFM tip, enabling the present invention to measure at even better resolutions than the ability to position the mechanical actuator itself. Furthermore the present invention may do so while the actuator is in motion. Nonlinearities of the mechanical actuator have no effect on the accuracy of the system. This enables real-time, on-the-fly recording of the AFM cantilever tip position at randomly selected positions.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the spirit and true scope of this invention as claimed below.

What is claimed is:

1. A silicon based scanning probe cantilever comprising of:
at least one reflective region on a top surface of said cantilever; and
at least one non-reflective region on the top surface of said cantilever.

2. A scanning probe cantilever of claim 1, wherein said reflective region is bound by at least one edge of said cantilever.

3. A scanning probe cantilever of claim 1, wherein said reflective and nonreflective regions form an optical grating structure.

4. A scanning probe microscopy tool, comprising:
a cantilever;
a light beam illuminating said cantilever with collimated light;
a detection system;
an actuation system; and
and a control system.

5. A scanning probe microscopy tool, comprising:
a cantilever;
a light beam that reflects off said cantilever wherein said light beam cross-section at intersection plane with said cantilever is larger than at least the width of said cantilever;
a detection system;
an actuation system; and
a control system.

6. A scanning probe microscopy tool of claim 5, wherein said light beam is selected from the group consisting of collimated light beam, quasi-collimated light beam, disperse light beam, and focused light beam.

7. A scanning probe microscopy tool of claim 5,
wherein the source of said light beam is fixed to the tool frame; and
wherein said cantilever is scanned.

8. A scanning probe microscopy tool of claim 5, wherein said light beam diffracts off said cantilever.

9. A scanning probe microscopy tool of claim 5, further comprising a plurality of cantilevers.

10. A scanning probe microscopy tool of claim 5, wherein position of said cantilever with respect to a reference frame is measured optically with the detection system.

11. A scanning probe microscopy tool of claim 10, wherein said reference frame comprises another cantilever.

12. A scanning probe microscopy tool, comprising:
a cantilever with at least one reflective region and at least one non-reflective region on a top surface of said cantilever;
a light beam that reflects off said cantilever wherein the cross-section of said light beam at an intersection plane with said cantilever is larger than said reflective surface,
a detection system;
an actuation system; and
a control system.

13. A scanning probe microscopy tool, comprising:
a cantilever;
a light beam that is AC modulated at a frequency that coincides with at least one resonant frequency of the cantilever;
a detection system;
an actuation system; and
a control system.

14. A scanning probe microscopy tool, comprising:
a cantilever,
a light beam which is AC modulated at a frequency that is multiplicative of at least one resonant frequency of the cantilever;
a detection system;
an actuation system; and
a control system.

15. A CD-AFM metrology tool, comprising:
a cantilever twisted about its long axis wherein a tip of said cantilever is adapted to access vertical and re-entrant surfaces of features;
a light source;
a detection system;
an actuation system; and
a control system.

16. A CD-AFM metrology tool of claim 15,
wherein said cantilever is twisted in one direction from the normal so as to scan one side of said feature; and
wherein said cantilever is twisted in the other direction from the normal so as to scan the other side of said feature.

17. A CD-AFM metrology tool of claim 15, wherein said feature is selected from the group consisting of lines, contact holes, vias, and trenches.

18. A CD-AFM metrology tool of claim 15, wherein said feature has a high aspect ratio.

19. A CD-AFM metrology tool of claim 15, wherein said cantilever is twisted with an angular stage.

20. A CD-AFM metrology tool of claim 15, wherein said cantilever is scanned in a circumferential direction with respect to a contact hole feature at a fixed feature height.

21. A CD-AFM metrology tool of claim 19, wherein said angular stage is fixed to an XYZ actuation system.

22. A CD-AFM metrology tool of claim 146, wherein said cantilever is rastered in a vertical Z direction.

23. A CD-AFM metrology tool, comprising:
a tip tilted with respect to a cantilever wherein said tip can access vertical and re-entrant surfaces,
a light source;
a detection system;
an actuation system; and
a control system.

24. A CD AFM metrology tool, comprising:
a cantilever;
a first light beam that reflects off said cantilever;
a first position sensitive detector that captures said first reflected light beam;
a second light beam that reflects off said first position sensitive detector;
a second position sensitive detector that captures said second reflected light beam;
an actuation system; and
a control system.
